(19) United States
(12) Patent Application Publication
(10) Pub. No.: US 2014/0346838 A1
(43) Pub. Date: Nov. 27, 2014

(54) Bicycle Backrest

(71) Applicant: David Wayne Smith, San Diego, CA (US)

(72) Inventor: David Wayne Smith, San Diego, CA (US)

(21) Appl. No.: 13/902,792

(22) Filed: May 25, 2013

(51) Int. Cl. B62J 1/28

(52) U.S. Cl. CPC B62J 1/28
USPC 297/452.48

(57) ABSTRACT

The device is a backrest for a bicycle that consists of three main parts. The backrest: a padded rectangular shaped device that attaches horizontally to a thick walled vertical post, that transverses downward at a 55° angle and is coupled with a thick walled cylindrical mounting bracket. The mounting bracket has a cylinder that accepts the seatpost of a bicycle, attaching the whole assembly to the frame.

### CROSS REFERENCE

Provisional patent application No. 61/706,800 filed Sep. 28, 2012 by David R. Wilson.

### FIELD OF INVENTION

The present invention relates to a backrest attached to the seatpost of a bicycle via a curved thick walled post inserted into a mounting bracket. The device is intended to support the back of rider alleviating stress on the back when riding.

### BACKGROUND OF INVENTION

Backrest for bicycles have previously been discovered as far back as March, 1899 (U.S. Pat. No. 6,206,88) and as recently as October, 1984 (U.S. Pat. No. 4,475,770) Persons, II.

The bicycle market has exploded over the last 10 years and continues to grow. This is attributed to the global economy, fitness craze, and the minimal impact the bicycle has on the environment. This raises some opportunities in a growing market. One of those is a backrest for a bicycle. The benefits of this product are numerous, as detailed in U.S. Pat. No. 2,853,12, by Shapiro, dated January 1957.

The lower back can take a pounding while riding a bicycle. This device provides support for the lower back, easing the impact, and can help prevent serious injury to the lumbosacral spine.

### SUMMARY OF INVENTION

The primary goal of this invention is to provide comfort and support to riders of various types of bicycles. This is achieved via a backrest with a combined assembly attached to the bicycle frame. The backrest is designed to support the rider at exactly the correct area of the lombardo scala to provide the most benefit and comfort. This is a lightweight, sturdy and securely mounted device for maximum safety of the rider.

### DESCRIPTION OF THE DRAWING

FIG. 1 is a side elevation view of the apparatus attached to a bicycle seatpost

FIG. 2 is a front view of the backrest only.

FIG. 3 is a blown up view of the mounting bracket.

### DETAIL DESCRIPTION OF PREFERRED EMBODIMENT

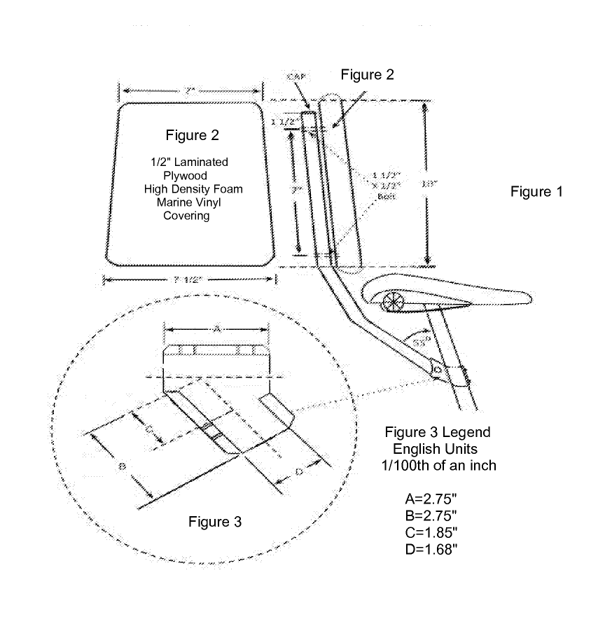

The bicycle backrest will now be described by referring to FIGS. 1-3 of the drawing. The bicycle backrest device attached to a bicycle seat post is generally designated FIG. 1. The device as detailed in FIG. 1 has mounting post which has a primary foam padded backrest (see FIG. 2) which is attached via ½″×1½″ bolts and nuts illustrated in FIG. 1. The mounting post as viewed in FIG. 1 is a cylindrical device attached to the mounting bracket via a 5/16″ set screw. The third device as seen in FIG. 1 is a cylindrical mounting bracket (see FIG. 3) attached the seatpost of a bicycle with two (2) 5/16″ set screws. This is a rigid device with no movable parts.

The foam padded backrest as depicted in FIG. 2 is a device consisting of 2″ high density foam, ½″ laminated plywood and a marine vinyl covering. It is rectangular shape with rounded corners for safety and comfort. This backrest as previously stated is attached to the mounting post (see FIG. 1) with two (2) 1½″×½″ nuts and bolts.

The mounting bracket as seen in FIG. 3 consists of two round (2) ⅛″ thick walled pipes welded together at 55° angle in order to accept the mounting post at the correct angle for optimum stability and safety. This device is attached to the seatpost of bicycle via two (2) 5/16″ set screws. The pipe has been drilled and tapped to accept three (3) set screws.

1. What is claimed is a device that attaches to the seatpost of a bicycle comprising of a padded backrest which; attaches to a mounting post; which attaches to a mounting bracket; which attaches to the seatpost of a bicycle.

2. The backrest as claimed in claim 1 is a padded rectangular device attached to the mounting post with nuts and bolts. The function of the backrest is to provide support and comfort to the bicycle rider.

3. The mounting post as claimed in claim 1 is attached to the mounting bracket by inserting the post into the mounting bracket and tightening a set screw. The function of the mounting post is to provide a frame to attach the backrest which; attaches to the mounting bracket which; attaches to the seatpost

4. The mounting bracket as claimed in claim 1 is attached to the seatpost by inserting the seatpost into the mounting bracket and tightening the set screws. The function of the mounting bracket is to attach the device to the seatpost; which attaches to the bicycle frame.
